(19) United States
(12) Patent Application Publication
(10) Pub. No.: US 2021/0296023 A1
(43) Pub. Date: Sep. 23, 2021

(54) CABLE WITH REDUCED SUSCEPTIBILITY TO BUCKLING BREAKAGE

(71) Applicant: SUMITOMO WIRING SYSTEMS, LTD., Yokkaichi-shi, Mie (JP)

(72) Inventors: Toshirou NAKAO, Yokkaichi (JP); Kenta FURUJOU, Yokkaichi (JP); Atsushi IKEDA, Yokkaichi (JP); Junichirou TSUJI, Yokkaichi (JP); Nobuyuki ISAMOTO, Yokkaichi (JP); Yuuta INOUE, Yokkaichi (JP); Osamu OKAMOTO, Yokkaichi (JP); Kenta KOBAYASHI, Yokkaichi (JP)

(73) Assignee: SUMITOMO WIRING SYSTEMS, LTD., Yokkaichi-shi, Mie (JP)

(21) Appl. No.: 16/325,128

(22) PCT Filed: Aug. 28, 2017
(86) PCT No.: PCT/JP2017/030716

§ 371 Date: Feb. 12, 2019

(30) Foreign Application Priority Data
Aug. 29, 2016 (JP) 2016-166806

(51) Int. Cl. H01B 7/02; H01B 7/04

(52) U.S. Cl. CPC H01B 7/02; H01B 3/302; H01B 7/04

(57) ABSTRACT

A cable including a plurality of internal insulated cores, each of which is formed by covering a conductor including a twisted wire with an insulator. The insulators have a tensile elastic modulus higher than that of a vinyl chloride resin for an electric wire and has a friction coefficient lower than that of the vinyl chloride resin for an electric wire. The cable may be a cab tire cable or a cab tire cord of a home appliance, a standard charger, or an on-board charger, for example, and is able to withstand long use without buckling breakage of the conductors.

This invention relates to a cable that can be used as a cabtire cord or a cabtire cable, for control and/or power supply of a home appliance, a standard charger, or the like, and particularly to a cable that can suppress generation of buckling breakage of an electric wire.

### BACKGROUND

Regarding a cabtire cord or a cabtire cable (hereafter simply referred to as a “cable”) that is used for a home appliance, a standard charger, on-board charging of a plug-in hybrid vehicle, or the like, an item using a vinyl chloride resin for an insulator covering a cable, such as, for example, a vinyl cabtire cord (VCTF) or a vinyl cabtire cable (VCT), is common and widely used. Such a cable is inexpensive, can be easily processed and is provided with a stable electrical characteristic.

Conventionally, to satisfy ease of handling such a cable, a flexible material is used. For example, as shown in FIG. 4, a cable 202 used in a blow dryer 200 is stored by winding the cable 202 about a blow dryer main body 201. When the blow dryer 200 is used, by repeatedly pulling out the cable 202, or repeatedly winding it up in a reel and pulling it out, the cable 202 becomes twisted, and internal insulated cores often break due to buckling (kinking).

Such breakage due to buckling depends on (i) a situation of how the internal insulated cores are handled, (ii) frequency of harsh use, (iii) bending radius, and (iv) force applied at the time of bending. There are many cases that such breakage is generated as early as less than two years. Such breakage due to buckling is a phenomenon that occurs as follows. To have a cable with flexibility, a specified number of internal insulated cores are twisted and formed. Because of this, when winding up the cable, as these twists are unwound, the unwound internal insulated cores will have extra length with respect to a cable axial direction. Furthermore, when pulling out the cable, the internal insulated cores with extra length are locally bent (buckled), and a conductor breaks at this buckled portion.

A cable with high flexibility is used for a home appliance, a standard charger, on-board charging of a plug-in hybrid vehicle, or the like such that anyone can easily use it. However, when a cable with high flexibility is used, the cable is easily bent, so the buckling phenomenon easily occurs with little force and/or few times of using the cable, and breakage is easily generated due to buckling. Because of this, realization of a cable that can suppress generation of cable breakage due to buckling is very much desired.

For a conventional cable whose object is to suppress such generation of buckling breakage, for example, a cabtire cable can be listed that comprises (i) a first insulated wire core including (a) a first conductor in which a plurality of wires are twisted and (b) a first insulated coating that is formed of an insulating resin material and covers a circumferential side of the first conductor; (ii) a plurality of second insulated wire cores each including (a) a second conductor in which a plurality of wires are twisted and (b) a second insulating coating that is formed of an insulating resin material and covers a circumferential side of the second conductor, and in which a diameter of the second insulated wire cores is equal to or smaller than that of the first insulated wire core; (iii) a sub wire core including a third insulating coating that is formed of an insulating resin material and covers a circumferential side of a sub twisted wire core in which the plurality of second insulating wire cores are twisted; (iv) an inclusion that is filled in a gap of a twisted wire core in which the first insulating wire core and the sub wire core are twisted; and (v) a fourth insulating coating that is formed of an insulating resin material and covers a circumferential side of a twisted wire core in which the inclusion is included, wherein a circumferential side of the sub twisted core of the third insulating coating is covered in a filled manner. For the material of the first insulating coating, PP (polypropylene), PVC (polyvinyl chloride), crosslinked PE (polyethylene), and the like are shown as examples (see Patent Reference 1).

Additionally, for example, as a conventional cable, there is a cabtire cable that uses, as a coating material, a crosslinked resin composition in which 5-80 parts by weight of fillers and 30-120 parts by weight of plasticizers are mixed with 100 parts by weight of an ion crosslinked polyvinyl chloride comprising (i) a copolymer of (a) vinyl chloride and (b) radical polymerizable unsaturated carboxylic acid having a free carboxyl group, and (ii) an ion crosslinked agent (see Patent Reference 2).

Furthermore, for example, as a conventional cable, there is also a sheath of a cable or a wire that is of a halogen-free flame-retardant polymer composition, that is, which is formed of a halogen-free flame-retardant thermoplastic composition for a wire and a cable of a composition including (A) a propylene polymer, (B) a thermoplastic elastomer (TPE), and (C) an expansive flame-retardant system including a piperazine component (see Patent Reference 3).

Patent Reference 1: P2016-110836A

Patent Reference 2: P2002-338765A

Patent Reference 3: P2015-212390A

### SUMMARY

As shown in the above Patent References 1 and 2, from the standpoint of high flexibility, conventional cables are mainly used that have a vinyl chloride resin, such as a vinyl cabtire cable (VCT) shown in JIS C 3312, for an insulator or a sheath. Additionally, as shown in the above Patent Reference 3, considering that flexibility and abrasion resistance are important, a cable using a halogen-free material is also used in some cases. However, while such conventional cables are flexible and are easy to handle, there was a problem that internal insulated cores are easily bent and buckled. Additionally, there was a problem that a vinyl chloride resin has a high coefficient of friction, so friction between internal insulated cores is large, and when they are bent, they do not move smoothly, and local bending and buckling are easily generated.

This invention reflects on the above problems. An object of this invention is to provide a cable that is insusceptible to buckling breakage by increasing the strength of internal insulated cores and reducing friction between the internal insulated cores so as to suppress local bending.

As a result of earnest study, after selecting a material for covering a cable and optimizing a characteristic of the material by trial and error, these inventors discovered a new type of excellent cable that can suppress generation of buckling breakage compared to a vinyl chloride resin for an electric wire that was conventionally used as a material for covering a cable.

That is, a cable according to this disclosure includes a plurality of internal insulated cores, each of which is formed by covering a conductor comprising a twisted wire with an insulator, wherein: the insulator has a tensile elastic modulus higher than that of a vinyl chloride resin for an electric wire and has a friction coefficient lower than that of the vinyl chloride resin for an electric wire. Thus, regarding a cable according to this disclosure, as a high tensile elastic modulus synergistically works with a low friction coefficient, (i) strength and elasticity of the cable both improve, (ii) further, friction generated on the cable also decreases, (iii) high durability can be obtained in which cable breakage does not occur even if the cable is wound several thousand times or more, and (iv) flexibility is also provided in which a force required for bending the cable is decreased. Thus, easy operability is provided, and the cable is durable for repeated bending use over a long period of time.

Furthermore, regarding a cable according to this disclosure, as needed, a 2.5 % tensile elastic modulus of the insulator is made to be 441 MPa or higher and 800 MPa or lower. Thus, by optimizing the tensile elastic modulus, the strength of the cable increases and durability improves, such that cable breakage does not occur even if the cable is wound several thousand times or more. At the same time, flexibility is also provided which reduces a force required for bending the cable. Thus, easy operability is provided, and the cable is durable for repeated bending use over a long period of time.

Furthermore, regarding a cable according to this disclosure, as needed, the insulator has an elastic region higher than that of the vinyl chloride resin for an electric wire. The elastic region is 6.7% or higher, and suppresses generation of buckling breakage. Thus, regarding a cable according to this disclosure, the elastic region is optimized within a range in which generation of buckling breakage is suppressed, and even if there is a difference in a circumferential length between the cable bending inner side and the cable bending outer side when the cable is bent, due to the flexibility (elasticity) of the cable, a high restoring force will be shown in which the once-stretched insulator easily returns to its original form. Because of this, regarding a cable according to this disclosure, generation of an excess region by the internal insulated cores becoming longer than the outside portion in a cable axial direction is suppressed, generation of buckling breakage is suppressed, and the cable is durable for repeated bending use over a long period of time.

Furthermore, regarding a cable according to this disclosure, as needed, a coefficient of static friction of internal insulated cores is 0.43 or lower, a coefficient of dynamic friction of internal insulated cores is 0.27 or lower, and generation of buckling breakage is suppressed. Thus, regarding a cable according to this disclosure, as a degree of friction between the internal insulated cores can be optimally maintained, and durability for a local bending operation improves. At the same time, ease of sliding between the internal insulated cores can also improve. Because of this, in a cable according to this disclosure, even if the cable is wound several thousand times or more, generation of buckling breakage is suppressed, and the cable is durable for repeated bending use over a long period of time.

### BRIEF DESCRIPTION OF THE DRAWINGS

FIG. 1(a) is a structural diagram using a cross-sectional view of a cable related to a first embodiment. FIG. 1(b) is a structural diagram using a cross-sectional view of a cable related to another embodiment.

FIG. 2 shows various experiment results of the number of times of winding at wire breakage (times) for various 2.5% tensile elastic moduli (MPa) of the cable related to the first embodiment.

FIG. 3(a) shows a result that is obtained as an index of strength (1) in which various 2.5% tensile elastic moduli of the cable related to the first embodiment are multiplied by a coefficient of static friction of internal insulated cores. FIG. 3(b) shows a result that is obtained as an index of strength (2) in which various 2.5% tensile elastic moduli are multiplied by a coefficient of dynamic friction of internal insulated cores. FIG. 3(c) shows a result of the number of times of winding at wire breakage for various elastic regions (%).

FIG. 4 is an explanatory view showing a state in which a conventional cable is used for a blow dryer.

### DETAILED DESCRIPTION OF EMBODIMENTS

### First Embodiment

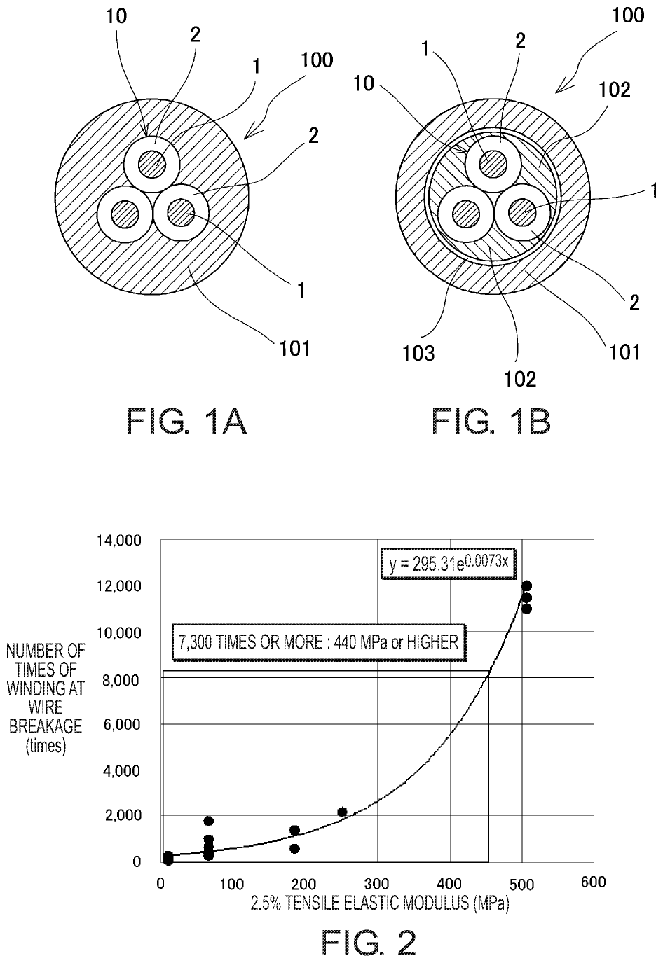

A cable related to a first embodiment is explained according to the structural diagram of FIG. 1(a).

As shown in FIG. 1(a), a cable 100 related to a first embodiment is provided with a plurality of internal insulated cores 10, each of which is formed by covering a conductor 1 comprising a twisted wire with an insulator 2, wherein the insulator 2 has a tensile elastic modulus higher than that of a vinyl chloride resin for an electric wire, and has a friction coefficient lower than that of the vinyl chloride resin for an electric wire.

Also, as shown in FIG. 1(a), the cable 100 related to the first embodiment has one or more internal insulated cores 10 formed by the conductors 1 and the insulators 2 (the figure shows three cores as an example) and has a sheath 101 that is molded to fill around the peripheries of the specified number of twisted internal insulated cores (insulated cores). As a material of the sheath 101, as long as it is a resin, it is not particularly limited, but from the viewpoint of ease of handling the cable, it is preferable to use polyvinyl chloride (PVC).

The conductors 1 formed by twisted wire are not particularly limited and can use various types of metal wires, for example, copper wires.

A material of these insulators 2 is not particularly limited, but in light of having a high strength, breakage resistant TPE (thermoplastic elastomer) is preferable. For such breakage resistant TPE, various resins can be used such as olefin-based thermoplastic elastomer (TPO), urethane-based thermoplastic elastomer (TPU), ester-based thermoplastic elastomer (TPEE), and amide-based thermoplastic elastomer (TPAE). For the above various resins, more specifically, for example, PBT (polybutylene terephthalate), PE (polyethylene), PP (polypropylene), PA6 (polyamide6), PA11 (polyamidell), PA12 (polyamide12), PET (polyethylene terephthalate), PBN (polybutylene naphthalate), PVDF (polyvinylidene fluoride), ETFE (ethylene tetrafluoroethylene), PTFE (polytetrafluoroethylene), PPS (polyphenylene sulfide), PEEK (polyether ether ketone), EVOH (ethylene vinyl alcohol copolymer), ABS (acrylonitrile butadiene styrene), EVA (ethylene vinyl alcohol), and PI (polyimide), more preferably PBT (polybutylene terephthalate), can be used.

Furthermore, the above tensile elastic modulus shows Young's modulus or elastic modulus (MPa), which refer to physical properties of a material showing ease of deformation, and is measured according to JIS (Japanese Industrial Standards) JIS K7127 (method of measuring a tensile elastic modulus). For example, as one index value that is used as a characteristic of a cabtire cable, an elastic modulus is listed that is measured when the cable is subjected to a strain of 2.5% with respect to the overall cable length (2.5% tensile elastic modulus).

Regarding the tensile elastic modulus of the insulators 2, as long as the tensile elastic modulus of the insulators 2 is higher than that of a vinyl chloride resin for an electric wire, it is not particularly limited, but it is more preferable that the 2.5% tensile elastic modulus is 441 MPa or higher and 800 MPa or lower. In this case, by optimizing the tensile elastic modulus, the strength of the cable 100 increases, breakage resistance increases even if the cable is wound several thousand times or more, flexibility is also provided that also decreases a force required for bending of the cable 100, easy operability is provided, and the cable is durable for repeated bending use over a long period of time.

If the 2.5% tensile elastic modulus is lower than 441 MPa, the strength tends to be weak and tends to be insufficient in order for the cable to withstand use for 10 years or more. Furthermore, if the 2.5% tensile elastic modulus is higher than 800 MPa, a force required for bending the cable 100 becomes large, so it tends to become difficult in practice to easily use the cable.

Additionally, the above coefficient of friction includes a coefficient of static friction and a coefficient of dynamic friction. The coefficient of static friction is a proportional constant that determines a maximum frictional force at the moment at which an object in a still state begins to move. The coefficient of dynamic friction is a proportional constant that determines a frictional force that is received by an object that moves at a fixed speed.

Regarding the coefficient of friction of the insulator 2, as long as the coefficient of friction of the insulator 2 is lower than that of a vinyl chloride resin for an electric wire, it is not particularly limited, but it is more preferable that the coefficient of static friction between the internal insulated cores 10 is 0.43 or less and that the coefficient of dynamic friction between the internal insulated cores 10 is 0.27 or less, which are ranges in which generation of buckling breakage is suppressed. In this case, a degree of friction between the internal insulated cores 10 of the cable 100 can be optimally maintained. Even if the cable 100 is wound several thousand times or more, generation of buckling breakage is suppressed, and the cable is durable for repeated bending use over a long period of time.

For other characteristics of the cable 100, in general, included are (i) a region (elastic region) having an elastic restoring force after stretching the cable 100 and (ii) a region (inelastic region) that does not have an elastic restoring force.

In this point, regarding the elastic region of the insulator 2, it is not particularly limited. More preferably, the elastic region of the insulator 2 is higher than that of a vinyl chloride resin for an electric wire, and the elastic region is 6.7% or higher, which is within a range in which generation of buckling breakage is suppressed. In this case, even if the elastic region is optimized within a range in which generation of buckling breakage is suppressed and there is a difference in a circumferential length between the cable bending inner side and the cable bending outer side when the cable 100 is bent, due to the flexibility (elasticity) of the cable 100, a high restoring force will be shown in which the once-stretched insulator 2 easily returns to the original form. Because of this, in this case, the internal insulated cores 10 are suppressed from becoming longer than the outside portion in a cable axial direction and generating an excess region, generation of buckling breakage is suppressed, and the cable is durable for repeated bending use over a long period of time.

Additionally, as long as the cable 100 of this embodiment is constituted by a cable provided with a plurality of internal insulated cores 10, each of which is formed by covering the conductor 1 comprising a twisted wire with the insulator 2, the subject and type are not particularly limited. The cable 100 can also be used as, for example, a harness cable formed by a bundle of a plurality of electric wires. Additionally, for example, the cable 100 does not depend on the shape of the cable end portion; thus, it can also be used as a cable (a cable with a connector) in which a connector used for connecting wiring for an electronic circuit or optical communication is mounted to the cable end portion. In this case, the cable 100 using a connector can be easily attached and detached. In any of the above cases, compared to a conventional cable, high strength and durability shown by the cable 100 of this embodiment can suppress cable deterioration caused by repeated usage. Furthermore, by applying the cable 100 of this embodiment to a cable with a connector, storing the cable 100 by winding it about the connector can be suppressed, and generation of breakage can be suppressed. That is, even if there is a situation in which the cable 100 is easily wound, such as the existence of a connector that becomes a subject of winding, generation of breakage can be suppressed.

### Other Embodiment

Furthermore, as shown in FIG. 1(b), a cable 100 related to another embodiment is constituted in the same manner as in the above first embodiment. Additionally, inclusion 102 can fill in around the peripheries of the internal insulated cores 10, and a press tape 103 that pressingly winds around the periphery of the inclusion 102 can also be provided inside of a sheath 101.

For the inclusion 102, there are: (i) a case in which polypropylene (PP), jute, paper, or the like is filled and (ii) a case in which a so-called inclusion sheath exists that encircles and covers the peripheries of the outer surfaces of the conductors 1 and the insulator 2. For a material constituting an inclusion sheath of the inclusion 102, as long as it is made of a resin, it is not particularly limited. For example, thermoplastic polyurethane (TPU), polyvinyl chloride (PVC), polyethylene, tetrafluoroethylene, and urethane can be used. For a material constituting the inclusion sheath, from the viewpoint of high strength and elasticity, it is preferable that urethane is used. In this case, a durability of double or more can be further acquired.

As long as the press tape 103 is a resin tape, it is not particularly limited. For example, a PET tape can be used. The press tape 103 along with the inclusion 102, twists together, and pressingly winds around, the conductors 1 and the insulators 2. By covering the sheath 101 over an outer surface of this press tape 103, the sheath 101 can be molded.

Thus, the structure including the press tape 103 inside further reinforces the strength and the elastic modulus inside the cable 100, and durability of the cable 100 can be further improved.

The following shows examples. The above cables are not limited by these examples.

### EXAMPLE 1

A cable of an example is provided with (i) three internal insulated cores formed by conductors and insulators and (ii) a sheath that is molded after these three internal insulated cores are twisted. For the insulators, PBT (polybutylene terephthalate) that is breakage resistant TPE (thermoplastic elastomer), PE (PE for electric wires), and XLPE (XLPE for electric wires) were used. In each of them that were used, the 2.5% tensile elastic modulus of each insulator was 441 MPa or higher and 800 MPa or lower.

To speed up the testing, the cables were wound about a mandrel of which the diameter is 1.5 times that of the cable outer diameter, and winding testing was performed that obtained the number of pull-out times at which wire buckling breakage occurred when the cable was repeatedly pulled out. The following table shows a result of the winding testing (3×2 mm²). Additionally, regarding the cables related to this example, FIG. 2 shows various testing results of the number of times of winding at which breakage of a wire occurs (times), for various 2.5% tensile elastic moduli (MPa). Additionally, as a comparative example, the following table also shows a result in which the insulators are PVC for electric wires.

TABLE 1

| | | | Coefficient of friction between | | |
|---|---|---|---|---|---|
| | | | internal insulated cores | | |
| | | | Coefficient | Coefficient | Average number of |
| | 2.5% tensile elastic | Elastic | of static | of dynamic | times of winding |
| Insulator | modulus (MPa) | region (%) | friction | friction | at breakage of cable |
| PE for | 184 | 2.5 | 0.281 | 0.296 | 1,000 |
| electric wires | | | | | |
| XLPE for | 250 | 2.7 | 0.460 | 0.350 | 2,200 |
| electric wires | | | | | |
| breakage | 506 | 7.5 | 0.412 | 0.262 | 11,500 |
| resistant TPE | | | | | |
| (comparative | 65 | 2.0 | 1.393 | 0.717 | 840 |
| example) PVC for | | | | | |
| electric wires | | | | | |

From the obtained results, it was confirmed that the cables related to this example have both high strength and durability, and that particularly when breakage resistant TPE (thermoplastic elastomer (TPE)) is used for the material for the insulators, the cable has extremely excellent durability.

In general, buckling breakage is generated as early as two years or less as the cable is used in a condition such as severe bending. Because of this, assuming that durability is provided in which an effect of extending the lifetime is five times or more and the lifetime of the cable is 10 years or more even if it is severely used, durability is required such that if the cable is wound and pulled out twice a day, breakage is not generated even if cable winding reaches 7,300 times or more.

According to the obtained results, it was confirmed that the cables related to this example are durable for 10 years or more of use because the 2.5% tensile elastic modulus is 441 MPa or higher. Additionally, regarding the cables related to this example, an upper limit value of the 2.5% tensile elastic modulus in which the cable is durable for bending use is 800 MPa or lower. Thus, it showed that a situation is avoided in which the cable is not easily used due to a large force being required when the cable is bent if the 2.5% tensile elastic modulus is higher than 800 MPa.

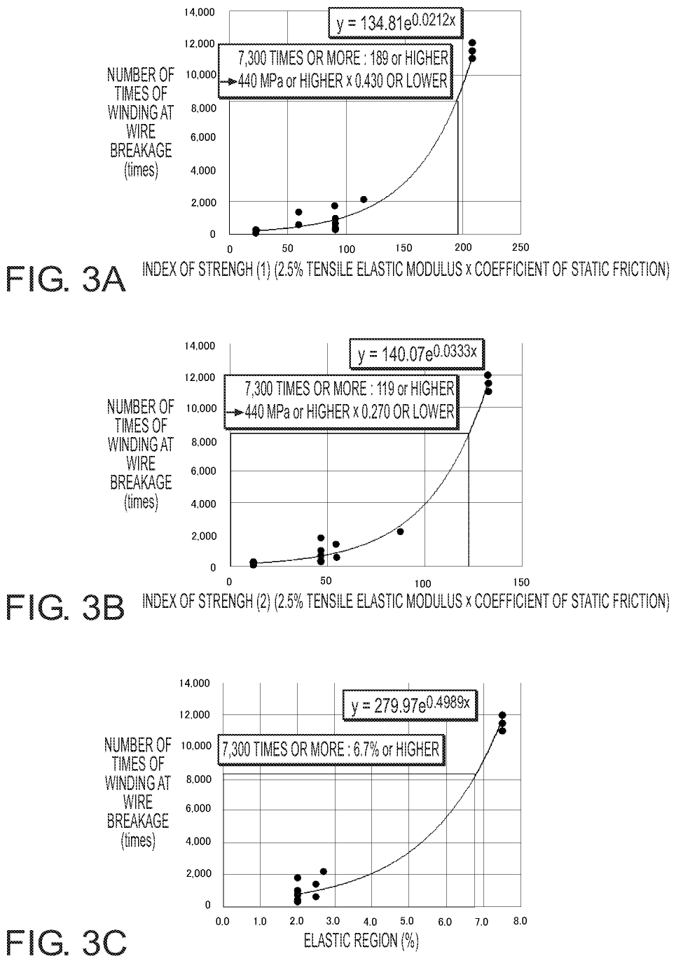

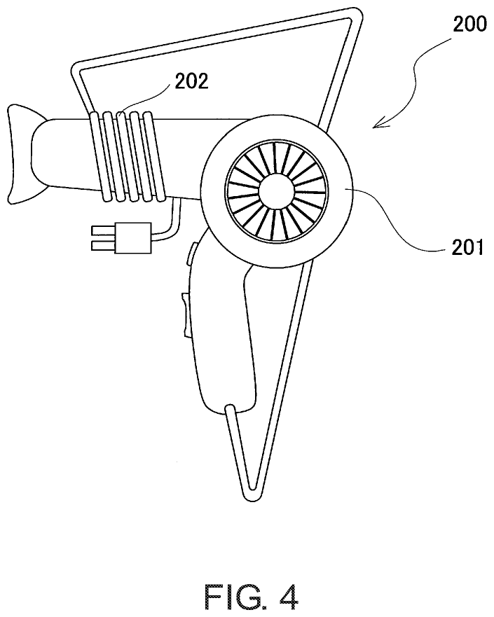

Furthermore, a multiplier effect with a sliding characteristic of the insulators was confirmed. That is, FIGS. 3(a) and 3(b) show results that were obtained as (1) an index of strength in which the 2.5% tensile elastic modulus is multiplied by a coefficient of static friction of the internal insulated cores and (2) an index of strength in which the 2.5% tensile elastic modulus is multiplied by a coefficient of dynamic friction of internal insulated cores. Based on the obtained results, by causing the coefficient of static friction of the internal insulated cores to be 0.43 or lower and causing the coefficient of dynamic friction of the internal insulated cores to be 0.27 or lower, the strength and elasticity of the insulators improve, and the friction decreases. Thus, compared to a conventional cable, it was confirmed that better suppression of cable breakage due to buckling is provided, and the cable can endure 10 years or more of use.

Normally, when the cable is bent, there is a difference in a circumferential length between the cable bending inner side and the cable bending outer side, and forces are applied by which the inner side is compressed and the outer side is stretched, so the radius of the bent cable significantly affects buckling breakage. Thus, the allowable bend radius of the cable is set, and the allowable bend radius of a cabtire cable is made to be equal to four times the outer diameter of the cable.

For example, when a vinyl cabtire cable VCT 3-core×2 mm² that is generally in frequent use is bent at a radius of four times an outer diameter, if elongation and contraction of the twisted cable are ignored, insulation of an outer side portion of the cable is theoretically stretched by 7.8%. When it is actually used, stretching of the insulators becomes smaller than a theoretical value due to the contraction, tightness, and opening of the twist. However, if the insulators are stretched because of a difference in a circumferential length due to bending, and a breakage region of the insulators does not stretch beyond this, the stretching does not recover, and the internal insulated cores become long and excessive in a cable axial direction. Thus, buckling breakage is easily generated. However, according to the result shown in Table 1 above and a result of the number of times of winding at wire breakage for each elastic region (%) shown in FIG. 3(c), durability was shown in which the elastic region of the insulators is 6.7% or higher and the number of times of winding at wire breakage is 7,300 times or more. Thus, in the cable, particularly using breakage resistant TPE, related to this example, the elastic region of the insulators is 6.7% or higher, so it was confirmed that the cable can endure 10 years or more of use.

What is claimed is:

1-5. (canceled)

6. An assembly, comprising:
a cable comprising a plurality of internal insulated cores, each of which is formed by covering a conductor comprising a twisted wire with an insulator, wherein:
a 2.5% tensile elastic modulus of the insulator is 441 MPa or higher and 800 MPa or lower,
the elastic region of the insulator is 6.7% or higher,
a coefficient of static friction of the internal insulated cores is 0.43 or lower, and
a coefficient of dynamic friction of the internal insulated cores is 0.27 or lower; and
a connector attached to an end of the cable.

7. The assembly according to claim 6, wherein each insulator is formed of thermoplastic elastomer.

8. The assembly according to claim 7, wherein the thermoplastic elastomer is selected from the group consisting of olefin-based thermoplastic elastomer, urethane-based thermoplastic elastomer, ester-based thermoplastic elastomer, and amide-based thermoplastic elastomer.

9. The assembly according to claim 6, wherein the insulator is formed of polybutylene terephthalate.

10. The assembly according to claim 6, wherein the cable is a cab tire cable or a cab tire cord of a home appliance, a standard charger, or an on-board charger.

11. The assembly according to claim 6, further comprising a sheath that is molded to fill around peripheries of the internal insulated cores.

12. The assembly according to claim 6, further comprising an inclusion that fills around peripheries of the internal insulated cores, a press tape that winds around a periphery of the inclusion, and a sheath that surrounds the press tape.

13. The assembly according to claim 12, wherein the press tape comprises a resin tape.
